(19) United States
(12) Patent Application Publication
(10) Pub. No.: US 2016/0139518 A1
(43) Pub. Date: May 19, 2016

(54) METHOD TO SIMULTANEOUSLY PROTECT A XEROGRAPHIC PHOTORECEPTOR FROM LIGHT SHOCK AND PROVIDE STARTUP LUBRICATION AT INSTALL

(71) Applicant: Xerox Corporation, Norwalk, CT (US)

(72) Inventors: Amir Prizant, Brighton, NY (US); Edward C. Savage, Webster, NY (US); David R. Voight, Webster, NY (US); Man Kit Yip, Webster, NY (US)

(21) Appl. No.: 14/546,215

(22) Filed: Nov. 18, 2014

(51) Int. Cl. G03G 5/147; G03G 21/00

(52) U.S. Cl. CPC G03G 5/147; G03G 5/14708; G03G 5/14734; G03G 5/14747; G03G 21/0094

(57) ABSTRACT

A removable protective coating for a photoreceptor that includes a colorant of a preselected color and a lubricant for providing initial lubrication to the photoreceptor and cleaning system blade or brush. The coating also includes a binding agent that is configured to attach the colorant and the lubricant together. The removable protective coating further includes a solution mixed with the colorant, the lubricant, and the binding agent, the mixed solution being applied to an exterior surface of the photoreceptor drying to form the removable protective coating. The removable protective coating is removed by the cleaning system during startup, providing lubrication to the cleaning system and the photoreceptor.

### BACKGROUND

The subject disclosure is directed to the xerographic arts, the photoreceptor arts, the imaging arts, the protective coating arts, the lubricating arts, and the like.

Photoreceptors are widely used in many xerographic imaging machines currently available in the industry. One of the inherent physical characteristics of a photoreceptor, which is required for successful operation, is photo-sensitivity to light. This characteristic makes it more difficult, from both a manufacturing and a maintenance point of view, to handle the photoreceptor and the installation process of copy cartridges or engineering replaceable unit (“ERU”) consumables that contain the photoreceptor. This is because the exposure of any unprotected area of the photoreceptor to most ambient lighting, both artificial and natural, can result in immediate light shock of the photoreceptor, the effects of which increase with exposure time and intensity resulting in degraded image quality and other problems in the imaging machine.

A first problem is that xerographic photoreceptors are likely to be exposed to ambient lighting during copy cartridge manufacturing or during installation in a copier/printer machine, typically in an office or work environment. Over exposure of any area of the photoreceptor to this lighting causes “light shock” and can result in uneven image density in the exposed area. Mild light shock is recoverable with time, but excessive light shock can damage the photoreceptor permanently. A second problem, which like light shock is related to handling the photoreceptor or cartridge in which the photoreceptor resides, pertains to contaminants on the drum, e.g., handling the drum can result in fingerprints, oils, dust, etc., on the drum. When the drum is handled, it has to be handled very carefully, typically with gloves or only from the ends, and protected from any other source of contaminants, which could be even cleaning products used in a facility. Typical solutions at the customer site are protective shields on copy cartridges, wrapping the photoreceptor or copy cartridge in light blocking wrappers, e.g., black paper, or using install tubes/shields that protect the photoreceptor/copy cartridge as it is installed in a machine. At a manufacturing site, special lighting may be used (e.g., yellow fluorescent, etc.) to minimize wavelengths to which the photoreceptor is especially sensitive. However, current manufacturing methodologies may not have the entire ERU manufactured in a single facility, i.e., the photoreceptor may be fabricated at a different location and shipped to the final assembly location, providing multiple opportunities for light shock or contamination to occur.

A third problem is that some form of lubrication is required to prevent the photoreceptor from being scratched by the cleaning blade, or having the cleaning blade tuck due to high friction between the photoreceptor surface and the cleaning blade at initial installation. Currently, this additional lubrication (e.g., zinc stearate powder, etc.) is applied to the photoreceptor surface or may be applied directly to the cleaning blade, or both.

Each of these conditions, i.e., light shock, contamination, and startup lubrication, are usually treated as separate and distinct problems, requiring separate treatment with correspondingly expensive implementations.

Thus, it would be advantageous to provide a single solution to these three problems, an inexpensive, environmentally green, combined light shock and contaminant protectant and startup lubricant coating for a photoreceptor.

### INCORPORATION BY REFERENCE

U.S. Pat. No. 8,765,334 B2 to Lin et al., issued on Jul. 1, 2014, and entitled PROTECTIVE PHOTORECEPTOR OUTER LAYER.

### BRIEF DESCRIPTION

In one embodiment of this disclosure, described is a removable protective coating for a photoreceptor. The removable protective coating includes a colorant of a preselected color and a lubricant for providing initial lubrication to the photoreceptor. The coating also includes a binding agent that is configured to attach the colorant and the lubricant to the photoreceptor surface. The removable protective coating further includes a solution mixed with the colorant, the lubricant, and the binding agent, the mixed solution being applied to an exterior surface of the photoreceptor drying or otherwise solidifying to form the removable protective coating.

In another embodiment of this disclosure, described is a light shock resistant imaging member that includes a photoreceptive surface and a removable protective coating adjacent to the photoreceptive surface. The removable protective coating includes a colorant, a lubricant, a binding agent, and a solution mixing the colorant, lubricant and binding agent applied to the photoreceptive surface forming the removable protective coating on the photoreceptive surface.

In another embodiment of this disclosure, described is one example of a typical image forming system having a developer apparatus that includes a housing defining a chamber storing a supply of toner, and a developer roll disposed in the chamber, the developer roll configured to rotate about a longitudinal access to transport toner via a developer roll to a development zone. The image forming system further includes a photoreceptor in close proximity to the developer roll. The photoreceptor is configured to rotate about a longitudinal access and receive toner on a surface of the photoreceptor from the developer roll in the development zone, with the photoreceptor surface having a removable protective coating disposed thereon. The removable protective coating includes a colorant comprising the toner, a lubricant, a binding agent, and a solution mixing the colorant, lubricant and binding agent applied to the photoreceptive surface forming the removable protective coating on the photoreceptive surface. The image forming system also includes a charging member in proximity to the photoreceptor, the charging member configured to generate a predetermined electrical charge on the photoreceptor, and a cleaning blade in contact with the surface of the photoreceptor configured to remove the removable protective coating therefrom during rotation of the photoreceptor. Additionally, the image forming system includes a transfer belt in contact with the photoreceptor, the transfer belt configured to receive an image formed on the photoreceptor of toner and transfer the image to an output media. In this embodiment, the transfer belt assembly contains its own cleaning blade to remove residual toner and any other material deposited by the photoreceptor from the transfer belt. The invention is not limited to this particular image forming system and has application to any similar system that use a cleaning blade or blade/brush combination to clean residual toner from the photoreceptor during the xerographic process.

In another embodiment of this disclosure, described is a method for producing a removable protective coating on an associated imaging member. The method includes determining a type of photoreceptor, determining a light shock sensitivity in accordance with the determined type of photoreceptor, and determining lubrication requirements associated with the determined type of photoreceptor and cleaning system containing a cleaning blade. The method also includes calculating an amount of a colorant, a lubricant, a binding agent, and a solution in accordance with the light shock sensitivity and lubrication requirements. In addition, the method includes applying the calculated amounts of colorant, lubricant, and binding agent in the solution to a surface of the associated imaging member drying to form the removable protective coating thereon.

### BRIEF DESCRIPTION OF THE DRAWINGS

FIG. 1 illustrates an example xerographic imaging apparatus according to an exemplary embodiment of this disclosure. Removed reference number 114 from the drawing to correspond to the deleted description of the functioning of the cartridge.

FIG. 2 is a detailed view of a cleaning blade used in the developer apparatus of FIG. 1. FIG. 2 has been updated. Thank you for the catch!

FIG. 3 is an illustration of the removable protective coating for a photoreceptor according to the exemplary embodiment of this disclosure. This statement does not belong in the description of the drawings; moved to further along in the detailed description.

FIG. 4 is an illustration of a photoreceptor belt utilizing the removable protective coating according to one embodiment of this disclosure.

FIG. 5 is a flowchart illustrating one example method for preparing the removable protective coating for a photoreceptor according to one embodiment of this disclosure.

FIG. 6 illustrates a color image forming machine according to an exemplary embodiment of this disclosure employing the developer apparatus and removable protective coating of FIGS. 1-3.

FIG. 7 illustrates a graph of halftone print density resulting from application of a protective coating on a photoreceptor in selected areas, exposing the protected and non-protected areas of the photoreceptor to room lighting, and subsequent removal of the removable protective coating from a photoreceptor in accordance with an example implementation.

FIG. 8 illustrates a graph of fractional transmittance verses density overlaid with the range of density measurements an example implementation of a removable protective coating for an imaging member in accordance with an example implementation.

### DETAILED DESCRIPTION

One or more embodiments will now be described with reference to the attached drawings, wherein like reference numerals are used to refer to like elements throughout.

As briefly discussed above, photoreceptive components of document processing devices, i.e., imaging members such as photoreceptive drums and belts, are susceptible to a variety of types of damages. Some damage may result from improper handling, e.g., oils from hands, scratches, etc., which damage the photoreceptive coatings on these components. Other types of damage may result simply from light shock, i.e., exposure to ambient lighting or light of specific wavelengths, degrade or otherwise damage the photoreceptive coatings on these components. Conventional protections require a technician to wear gloves to prevent damage from skin contact, be exceedingly careful during handling and insertion of the components, and further quickly insert such components to prevent damage from light shock. Physical damage protection, e.g., nicks, scratches, etc., includes bulky packaging, which may also include light resistive articles, e.g., opaque paper wraps, etc.

A cleaning blade requires an external lubricant to prevent damage during initial startup of mechanical operation. The application of this lubricant directly to the photoreceptor, may increase the chances for physical damage (scratching by the technician using the lubrication applicator) or light shock (the technician takes too long to apply the lubricant). The application of this lubricant directly to the cleaning blade is an additional expensive manufacturing step. The light shock resisting and lubrication containing coating for an imaging member, such as a photoreceptor drum, or photoreceptor belt, overcomes such difficulties in a more efficient, safe, and economical manner.

According to one aspect of this disclosure, provided is the ability to protect an imaging member, such as a photoreceptor component, and provide initial lubrication via a removable coating having protective, light resistive, and lubrication properties. The coating, or protective outer film, may be applied to the photosensitive surface of the imaging member during manufacture prior to packaging. The protective outer film is opaque in nature, preventing the photoreceptive portion of the imaging member from exposure to ambient light. The coating is configured to form a protective film on the imaging member without damaging the photoreceptive properties thereof.

According to another aspect, the removable coating comprises a binding agent, a coloration/light blocking component (colorant, pigment, etc.), and a corresponding solution to form a paste or solution applicable to the photoreceptor component of the imaging member. The paste may be applied to the photoreceptor drum or belt during manufacture, whereupon the paste hardens to form the hard outer film or shell on the photoreceptive component. During operations of the document processing device, the hardened layer of protective coating is cleaned from the imaging member via a cleaning blade. The coating formulation is configured to yield this property, that the coating breaks apart into suitable, relatively uniform pieces, capable of providing startup lubrication for the imaging member and capable of removal by the cleaning system. It will be appreciated that the removable, protective coating described herein further serves to eliminate the occurrence of fingerprints or other contaminants on the drum or belt, e.g., a service technician could pick up the drum and handle it with bare hands, and not touch the surface of the photoreceptor during installation/replacement.

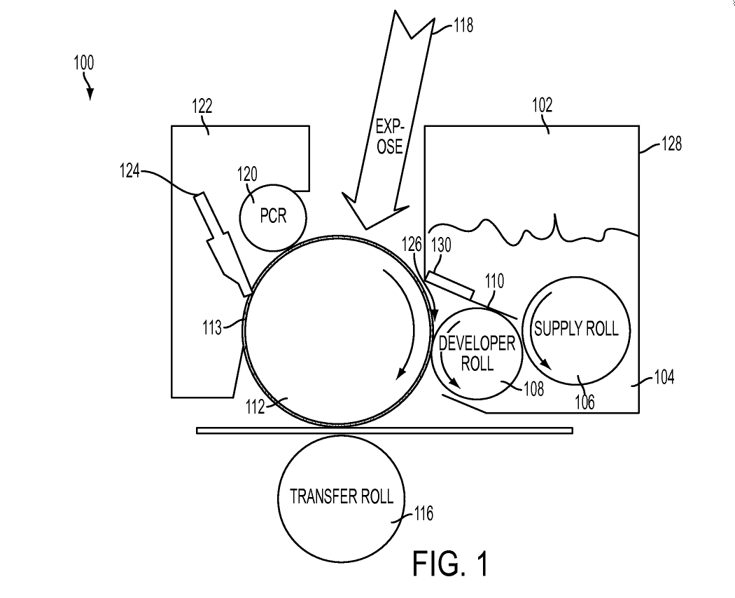

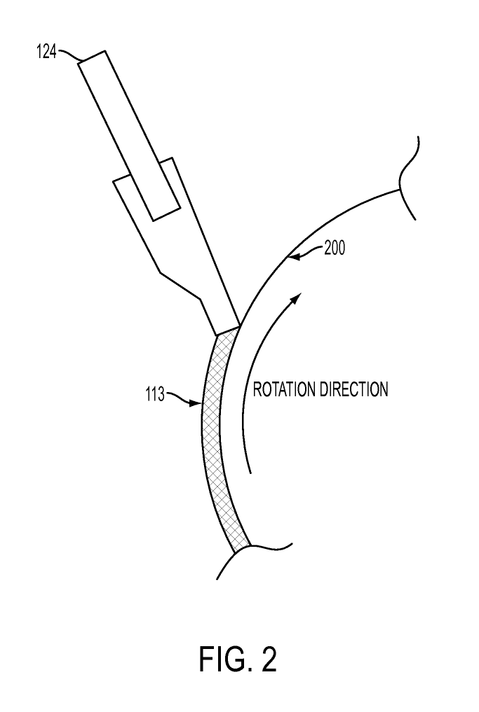

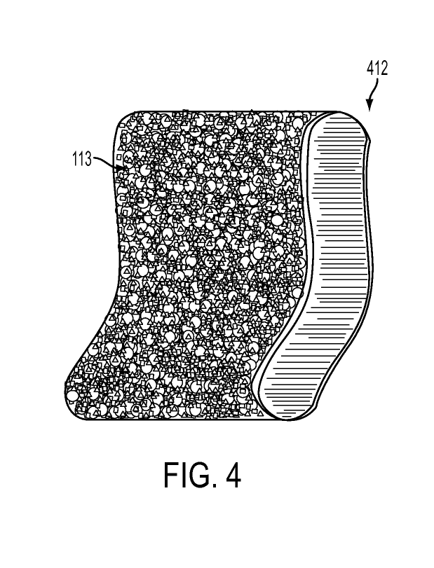

With reference to FIGS. 1 and 2, there is shown a cross section of a single component development apparatus 100 employing a removable protective coating 113 on an imaging member in accordance with one embodiment. It will be appreciated that the example of FIGS. 1 and 2 are representative of any type of development apparatus including two component development systems and include solid and liquid ink development systems and are used to illustrate components and operation of a suitable development apparatus. Accordingly, the development apparatus 100 of FIGS. 1 and 2 is used as an example only. FIG. 4 presents a belt-type photoreceptor 412 having the removable protective coating 113 applied thereto in accordance with the embodiments set forth herein. Accordingly, when discussed hereinafter, reference may be made to the drum photoreceptor 112, the belt photoreceptor 412, or both. It will be appreciated that unless specifically noted otherwise, the terms may be used interchangeably.

The apparatus 100 includes a development housing 128 that may include a cartridge sump 102 in which is stored toner 104. The toner 104 may be a conventionally produced toner, a chemically produced toner (e.g., via suspension polymerization or emulsion aggregation), or the like. For example purposes, reference is made hereinafter to the toner 104 being representative of a conventionally produced toner using a mechanical process. For example, a base plastic is melt mixed in a pigment and special ingredients to form a block of composite plastic of the basic toner material. This composite block of toner material is then pulverized via a mechanical action to a fine powder. The fine powder must then be properly filtered to remove oversized chunks and ultra-fine particles. The material remaining is typically non-uniform angular particles, with a somewhat wide distribution of size and shape.

During mechanical operation, the removable protective coating 113 is then removed by the cleaning blade 124, breaking apart into relatively uniform pieces, i.e., pieces of the pigment/colorant component 302, the binding agent 304, and the lubricant component 308. The broken apart coating 113, thus removed from the surface 200 of the photoreceptor 112, then facilitates lubrication thereof for subsequent operation of the development apparatus 100. It will be appreciated that the breakup of the coating 113 into a predetermined particle size is an outcome of the formulation and optimized for the particular application.

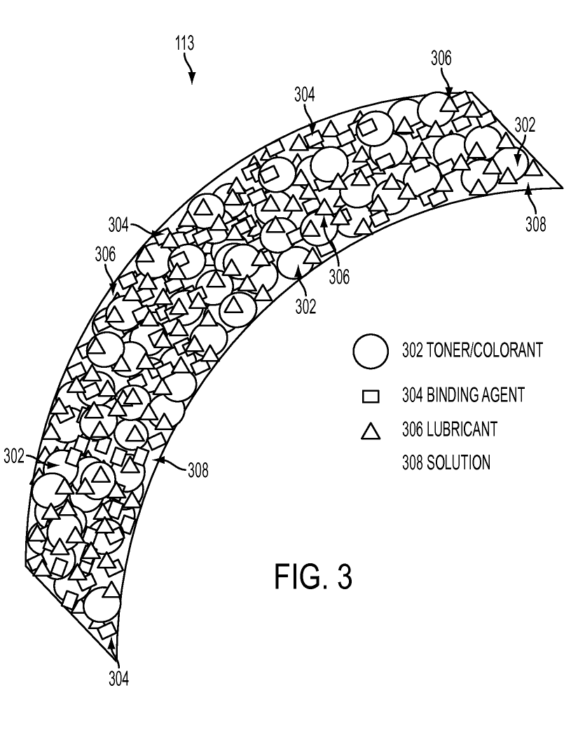

FIG. 3 provides an illustrative example of the various components of the protective coating 113 in accordance with one embodiment contemplated herein. As depicted in FIG. 3, the removable protective coating 113 comprises a pigment/colorant component 302, a binding agent 304, and a lubricant component 306, and a solution 308.

In accordance with one embodiment, the pigment/colorant component 302 is a suitable light blocking material capable or blocking a predetermined percentage of light. The pigment/colorant component 302 may comprise a toner, the toner color corresponding to the color of the toner 104 used in the development apparatus 100. It will be appreciated that the amount of pigment/colorant component 302, e.g., toner 104, may be dependent upon the color of the toner 104. For example, to block the same predetermined percentage of light as using black toner, a greater amount of cyan, magenta or yellow toner would be required. It will be appreciated that the pigment/colorant component 302 may be configured to block certain wavelengths of visible light, e.g., 400 nm to 515 nm. Other wavelengths to which the photoreceptor 112 or 412 may be particularly sensitive may also be blocked in accordance with the embodiments set forth herein. According to one embodiment, the pigment/colorant component 302 comprises fine particulates of toner material 104 that is non-reactive with the surface 200 of the photoreceptor 112 or 412. Furthermore, the selected toner 104 may be dependent upon the type of document processing device into which the photoreceptor 112 or 412 is inserted.

The binding agent 304 (depicted in FIGS. 3 and 4) functions to hold the pigment/colorant component 302 and the lubricant component 306, in stationary suspension and provide a level of adhesion between these components 302 and 306 and the surface 200 of the photoreceptor 112. It will be appreciated that such a binding agent 304 does not form a chemical bond with either the pigment/colorant component 302 or the lubricant component 306, instead holding each other component 302 and 306 in suspension. In addition, all components of the formulation must be non-reactive with the surface 200 of the photoreceptor 112 or 412. In accordance with one embodiment, the binding agent 304 comprises a non-reactive starch, e.g., cornstarch, rice starch, etc. It will be appreciated that other suitable binding agents 304 may be used in accordance with the disclosure set forth herein.

The lubricant component 306 may comprise a powdered lubricant used in document processing devices and safe for use on photoreceptors 112 or 412. In accordance with one embodiment, the lubricant 306 comprises a stearate powder, e.g., magnesium stearate, zinc stearate, etc. According to another embodiment, the lubricant 306 comprises a polymethylmethacrylate (“PMMA”). However, other suitable lubricants used in the xerographic process may be used.

The solution 308 may comprise a mild, evaporative solvent, i.e., an evaporative liquid compound that suspends the various components 302, 304, and 306 to allow even application of the coating 113 to the photoreceptor 112 or 412. According to one embodiment, the solution 308 comprises water and an alcohol, such as isopropanol. It will be appreciated that the solution 308 may be dependent upon the type of binding agent 304 selected, the reactivity of the toner/colorant 302, and the reactivity of the lubricant 306. In one embodiment, the viscosity of the coating 113 prior to solidification is modified to achieve sufficient application thereof to the photoreceptor 112 or 412. The application of the removable protective coating 113 may be via any suitable means, e.g., brushed, dipped, sprayed, or the like. The thickness of the coating 113 using black colorant 302, may range between 5 um and 500 um. It will be appreciated that the thickness of the coating 113 may change depending on the colorants are used, to achieve a desired light blocking percentage.

In the depiction of FIGS. 3 and 4, the components 302, 304, 306, are homogenously distributed but they can also be layered or exist in any distribution pattern. For example, one embodiment utilizes distinct layers of lubricant 306 and toner 302 without the use of the binding agent 304 or with lesser amounts of binding agent 304 required. In such an example embodiment, application of the layers may require solution 308 to be separately incorporated with the individual layers, e.g., solution 308 and lubricant 306 mixed and applied following the drying of such lubricant layer, solution 308 and toner 302 is mixed and applied. Added benefits or characteristics of such an implementation may be a harder or softer protective coating 113 around the photoreceptor 112 or 412. Variations of the embodiments discussed herein are contemplated in accordance with the teachings contained herein.

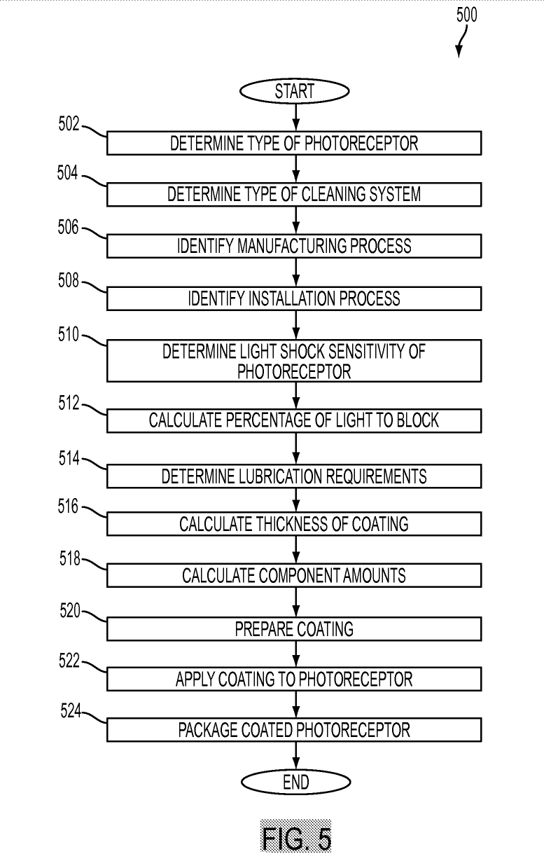

Not sure why we are describing a single component development system? The actual experiments were conducted using a two component development system. Please providing a working definition of both a single component development system and a two component development system. In addition, if you have a drawing, image, etc., please forward that on as well. I can modify the description as needed to include the definition and add the drawing with a description indicating the location of the photoreceptor, coating, cleaning blade, etc. Turning now to FIG. 5, there is shown a flowchart 500 illustrating an example methodology of preparing and applying the removable protective coating 113 in accordance with embodiments set forth herein. As such, steps may be combined or additional steps added as required in practice. The methodology 500 begins at 502, whereupon the type is determined. That is, whether the photoreceptor is a drum photoreceptor 112, (and other relevant information, e.g., toner color, size, and the like), or a belt photoreceptor 412 (and other relevant information, e.g., toner color, size, width/length, flexibility, type of cleaning system (blade, brush, etc.), and the like). The type of cleaning system associated with the photoreceptor 112 or 412 is then determined at 504. As will be appreciated, the photoreceptor 112 may utilize a different type of cleaning system, e.g., cleaning blade, than the photoreceptor belt 412, e.g., cleaning brush(es). As such, the different cleaning systems may impact the composition of the removable protective coating 113, e.g., the thickness of the coating 113, the type/amount of lubricant 306, the amount of binding agent 304, etc.

At 506, the manufacturing process that is used to manufacture the photoreceptor drum 112 or belt 412 is identified. It will be appreciated that the manner in which fabrication is performed may affect the formulation and preparation of the removable protective coating 113. The installation process associated with the determined type of photoreceptor 112 or 412 is then identified at 508. According to one embodiment, the type of installation, e.g., position of cleaning blade, components to be lubricated, etc., may affect the formulation and the preparation of the removable protective coating 113. For example, a belt-type installation may require longer exposure or more handling than a drum-type installation. Further, the installation of the photoreceptor, e.g., OEM as opposed to in-field repair may affect the coating 113, i.e., OEM manufacture and installation may be done under suitable lighting conditions while in-field repair utilizes ambient lighting, thus affecting the coating 113.

At 510, the light shock sensitivity of the determined photoreceptor 112 or 412 is determined. It will be appreciated that various photoreceptors may have different sensitivity levels to light shock depending upon the type of application, device in which they are installed, the particular type of toner used, the particular color of toner used (if applicable), and the like.

The percentage of light to block is then calculated at 512 and the lubrication requirements associated with the determined type of photoreceptor 112 or 412 are determined at 514. It will be appreciated that the percentage of light to block may be calculated in accordance with the light shock sensitivity of the photoreceptor 112 or 412, the colorant 302, the installation and manufacturing processes, and the like. The lubrication requirements, as will be appreciated, may be determined based upon whether the drum 112 is to be inserted into a cartridge unit (shown in FIG. 1) or packaged for after-market repair (installation process), etc.

After determining the various processes, sensitivities, properties, and the like, operations proceed to 516, whereupon the thickness of the removable protective coating 113 is calculated. It will be appreciated that the thickness may be dependent on the various information determined above at 502-514, including, for example, the position of the cleaning blade or brush, the position of the charging blade, the position of the metering blade (if present), etc. It will be appreciated that when color-specific drums are used, it may become necessary to adjust the thickness of the protective coating 113 for each specific color toner to allow for sufficient protection of the underlying photoreceptor 112 from light shock, i.e., black toner will provide better protection against light shock than cyan, magenta, or yellow toner, thus the latter three will require varying amounts of toner colorant 302 to facilitate a suitable level of protection.

After calculation of the thickness, operations protected to 518, whereupon the amounts of the various components 302, 304, 306, and 308 are calculated in accordance with the determined thickness, the percentage of light block, the lubrication requirements, the type of photoreceptor 112 or 412, the cleaning system, the installation process, and the like.

At 520, the removable, protective coating 113 is prepared in accordance with the calculated amounts of the components 302, 304, 306, and 308. The coating 113 is then applied to the photoreceptor 112 or 412 at 522 during the manufacturing thereof. Application of the coating may be performed via the use of brushes, spraying, submersion (dipping) of the photoreceptor into the coating 113, or the like. The coated photoreceptor 112 or 412 is then packaged at 524 for subsequent transfer or installation.

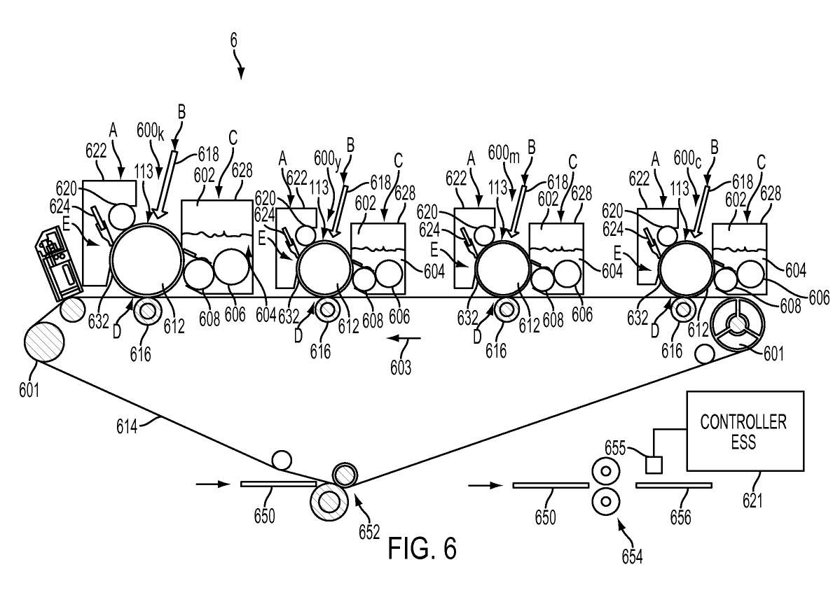

Turning now to FIG. 6, there is illustrated an example image forming machine 6 implementing the developer apparatus 600 having a photoreceptor 612 protected by a removable protective coating 113. The image forming machine 6, can be a xerographic or electrophotographic image forming device such as a multi-color digital printer, a digital color copy system, or the like. It includes a plurality of marking engines, depicted in FIG. 6 generally as the developer apparatus 600, forming associated color separations that are combined to form a color print image, as described in further detail below. It will be appreciated that while illustrated in FIG. 6 as a multicolor image forming machine, it will be appreciated that the developer apparatus 600 depicted in FIG. 3 may be implemented in a single marking engine device, i.e., a monochromatic image forming device, and the use of a multicolor device herein is intended for example purposes only. Hereinafter, with respect to FIG. 6, the terms “developer apparatus” and “marking engine” are used interchangeably unless otherwise set forth.

The image forming machine 6 shown by way of example is of a tandem architecture system including an intermediate transfer belt 614 entrained about a plurality of rollers 601 and adapted for movement in a process direction illustrated by arrow 603. Belt 614 is adapted to have transferred thereon a plurality of toner images, which are formed by the developer apparatuses referred to generally at 600.

Each developer apparatus 600 forms an associated color separation by developing a single colorant toner image in succession on the belt 614 so that the combination of the color separations forms a multi-color composite toner image. While the color separations may be combined in different ways, they are each separately developed onto associated photoreceptors and then transferred to a compliant single-pass intermediate belt 614. When all of the desired color separations have been built up on the intermediate belt 614, the entire image is transfixed to substrate, such as paper, to form a print image.

For the purposes of example, which should not be considered limiting, the image forming machine 6 described herein is a CMYK marking system having four marking engines, i.e., developer apparatuses 600, which include: a cyan developer apparatus 600_{C} forming a cyan color separation; a magenta developer apparatus 600_{M} forming a magenta color separation; a yellow developer apparatus 600_{Y} forming a yellow color separation; and a black developer apparatus 600_{K} forming a black separation. However, it should be appreciated that a larger or smaller number of marking engines 600 can be used. For example, a larger number of marking engines 600 can be used for generating extended colorant set images which typically include these four process-color colorant separations (CMYK) plus one or more additional color separations such as green, orange, violet, red, blue, white, varnish, light cyan, light magenta, gray, dark yellow, metallics, and so forth.

In other examples, the image forming machine 6 can be an n-color imaging system (with n≧3) having n+1 marking engines 600, where the n+1^{th} marking engine 600_{OC} uses clear toners for form an overcoat layer on top of the other toners in the printed image. In one non-limiting example, an image forming machine may include marking engines 600_{OC}, 600_{C}, 600_{MK}, 600_{Y} and 600_{K} consecutively coupled to the intermediate transfer belt 614, as will be appreciated.

Each developer apparatus 600_{C}, 600_{M}, 600_{Y}, and 600_{K} includes a charge retentive member in the form of the drum-shaped photoreceptor 612, having a continuous, radially outer charge retentive surface 605 constructed in accordance with well-known manufacturing techniques. The photoreceptor 612 is supported for rotation such that its surface 605 moves in a process direction shown at 603 past a plurality of xerographic processing stations (A-E) in sequence. Each photoreceptor 612 includes a removable protective coating 113 on the surface 632 thereof. In the embodiment depicted in FIG. 6, each individual photoreceptor 612 may utilize either the same coating 113, or may have coatings 113 specific to the particular development apparatus 600_{K}, 600_{Y}, 600_{M}, 600_{C} in which the respective photoreceptor 612 is emplaced. That is, according to one embodiment, the colorant 302 of the coating 113 may be black toner 604 on each photoreceptor 612 so as to provide suitable light shock protection. In another embodiment, each specific photoreceptor 612 utilizes a different colorant 302 comprising the specific toner 604 of the development apparatus 600, e.g., black toner pigment for 600_{K} apparatus, yellow toner for 600_{Y} apparatus, magenta toner for 600_{M} apparatus, cyan toner for 600_{C} apparatus, etc. It will be appreciated that such coatings 113 may entail different amounts of colorant/toner to achieve the necessary light protection levels, as some toners may require higher concentrations to effectuate the same level of protection, e.g., more yellow toner than black toner, etc. It will further be appreciated that other color toners 604 may be used in accordance with the subject disclosure, and the use of black, yellow, magenta, and cyan are included herein for example purposes.

At the initial use of the image forming machine 6, or upon installation of any new development apparatus 600_{K}, 600_{Y}, 600_{M}, 600_{C} or replacement of a photoreceptor 612, the coated photoreceptor 612 encounters the cleaning blade 624. As the cleaning blade 624 begins to remove the protective coating 113 from the surface 632 of the photoreceptors, lubricant 306 bound in the coating 113 is freed to allow the cleaning blade 624 to clean the photoreceptor 113 without tucking or damaging the surface 632. According to one embodiment, the lubricant 306 is a powder-based lubricant such as a stearate. Breakup of the coating 113 reduces the coating 113 to its constituent parts (absent the evaporated solution 308), such that the toner/colorant 302 and binding agent 304 are collected in the cleaning housing 622 while the lubricant 306 coats the cleaning blade 624. The manner in which the colorant 302 and binding agent 304 are collected corresponds to the manner in which unused toner 604 is removed from the photoreceptor 612 prior to exposure 618 to the next image.

After initial startup of a particular development apparatus 600_{K}, 600_{Y}, 600_{M}, 600_{C}, successive portions of the photoreceptor surface 632 pass through a first charging station A during operations of the image forming machine 6. At charging station A, a corona discharge device indicated generally at 620, charges portions of the photoreceptor surface 632 to a relatively high, substantially uniform potential during a charging operation.

Next, the charged portions of the photoreceptor surface 632 are advanced through a first exposure station B. At exposure station B, the uniformly charged photoreceptor charge retentive surface 632 is exposed to a scanning device (referenced generally as exposure 618) that causes the charge retentive surface to be discharged forming a latent image of the color separation of the corresponding engine. The scanning device generating the exposure 618 can be a Raster Output Scanner (ROS), non-limiting examples of which can include a Vertical Cavity Surface Emitting Laser (VCSEL), an LED image bar, or other known scanning device. The ROS generating exposure 618 is controlled by a controller 620 to discharge the charge retentive surface in accordance with the digital color image data to form the latent image of the color separation. A non-limiting example of the controller 621 can include an Electronic Subsystem (ESS) shown in FIG. 6, or one or more other physical control devices. The controller 621 may also control the synchronization of the belt movement with the engines 600_{C}, 600_{M}, 600_{Y}, and 600_{K} so that toner images are accurately registered with respect to previously transferred images during transfer from the latter to the former.

The marking engines 600_{C}, 600_{M}, 600_{Y}, and 600_{K} also include a development station C, also referred to as a development housing 628. The development housing 628 includes a chamber 602 holding toner 604. The development housing 628 includes one or more supply rolls 606 for moving the toner 604 into contact with a magnetic brush, roller, or other toner applicator, indicated generally as the developer roll 608 (as shown in FIG. 1), advancing the toner 604 into contact with the electrostatic latent images on the photoreceptor 612 to form the toner image for the associated color separation as controlled by controller 621. The toner 604 not applied to the surface 632 of the photoreceptor 612 is moved to a waste receptacle (not shown) for removal.

At a transfer station D, an electrically biased transfer roll 616 contacting the backside of the intermediate belt 614 serves to effect combined electrostatic and pressure transfer of toner images from the photoreceptor 612 of the developer apparatus 600 to the transfer belt 614. The transfer roll 616 may be biased to a suitable magnitude and polarity so as to electrostatically attract the toner particles from the photoreceptor 612 to the transfer belt 614 to form the toner image of the associated color separation on the transfer belt 614.

After the toner images are transferred from the photoreceptor 612, the residual toner particles carried by the non-image areas on the photoreceptor surface are removed from it at cleaning station E. A cleaning housing 622 supports therewithin a cleaning blade/brushes 624 which remove the toner 604 from the photoreceptor surface 632.

After all of the toner images have been transferred from the engines 600_{C}, 600_{M}, 600_{Y}, and 600_{K} the multi-color composite toner image is transferred to a substrate 650, such as plain paper, by passing through a conventional transfer device 652. The substrate 650 may then be directed to a fuser device 654 to fix the multi-color composite toner image to the substrate to form the color print 656. The fuser device 656 may include a heated fuser roller and a back-up roller (not shown), such that the back-up roller is resiliently urged into engagement with the fuser roller to form a nip through which the sheet of paper passes. In the fusing operation, the toner particles coalesce with one another and bond to the sheet in image configuration, forming a multi-color image thereon. After fusing, the finished sheet is discharged to a finishing station where the sheets are compiled and formed into sets, which may be bound to one another. These sets are then advanced to a catch tray for subsequent removal therefrom by the printing machine operator.

Example Implementation:

According to one experimental implementation, the following components were mixed together. PMMA powder (lubricant), toner (colorant/pigment), cornstarch (binding agent), and isopropanol (solution). The resulting paste was applied to selected areas of a drum-type photoreceptor. Additional isopropanol was added to thin out the mixture for easier application and more patches were placed on the PR surface. This applied coating was allowed to dry for an extended period of time, e.g., at least twelve hours.

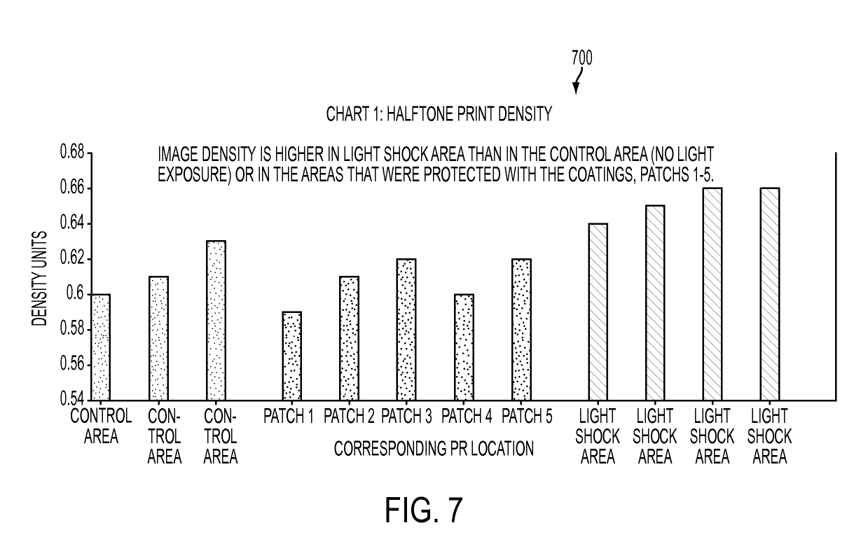

Photoreceptor light shock was then induced on the photoreceptor using a fluorescent lamp (D50 lighting) for approximately 10 minutes. The ERU was installed in a document processing machine. The machine went through normal xerographic setup. Resulting prints showed the effect of light shock in the exposed areas of the photoreceptor. The adjacent areas of the photoreceptor protected by the coating did not show the effects of light shock on halftone prints. The image density corresponding to protected and non-protected areas of the photoreceptor was measured and compared to a control (non-light shocked) area of the photoreceptor. As shown in FIG. 7, the light shocked areas of the photoreceptor produce darker image than either the control area or protected areas of the photoreceptor.

### Light Transmission Experiments

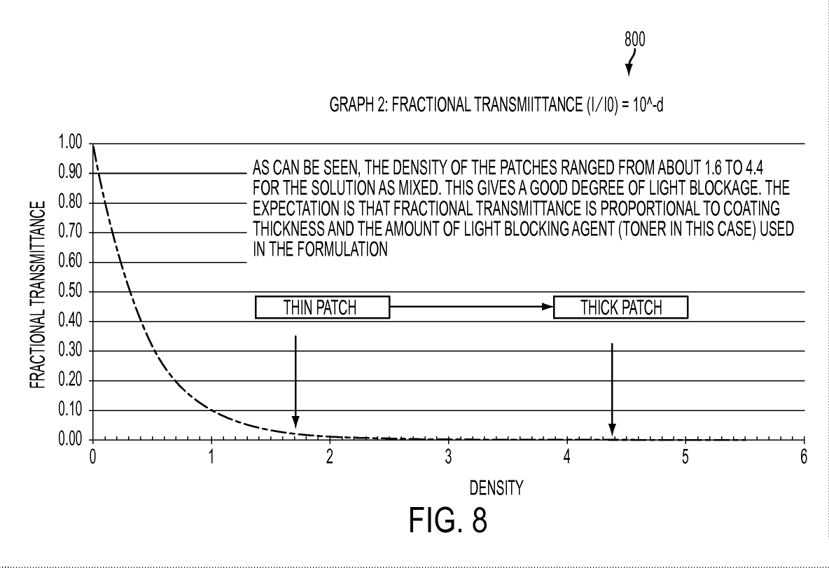

The same coating solutions made in test 2 were applied to transparency material and allowed to dry. These solutions presented good adhesion even when the transparency was rolled into the same diameter as the photoreceptor. Next, several of the patches were measured for transmission density using a Macbeth TR927 densitometer. FIG. 8 shows Fractional Transmittance verses Density overlaid with the range of density measurements made of the coating. The data shows that coating thickness could be optimized for light shock protection.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A removable protective coating for a photoreceptor, comprising:
a colorant of a preselected color;
a lubricant for providing initial lubrication to the photoreceptor;
a binding agent configured to attach the colorant and the lubricant together; and
a solution mixed with the colorant, the lubricant, and the binding agent, the mixed solution applied to a surface of the photoreceptor drying to form the removable protective coating.

2. The removable protective coating of claim 1, wherein the colorant is a toner.

3. The removable protective coating of claim 2, wherein the photoreceptor is a belt type photoreceptor.

4. The removable protective coating of claim 2, wherein the photoreceptor is a drum type photoreceptor.

5. The removable protective coating of claim 4, wherein the preselected color corresponds to a color of the toner used in a development apparatus in which the photoreceptor is emplaced.

6. The removable protective coating of claim 2, wherein the lubricant is a stearate powder lubricant.

7. The removable protective coating of claim 6, wherein the stearate powder lubricant is selected from the group consisting of magnesium stearate, zinc stearate, or polymethylmethacrylate.

8. The removable protective coating of claim 2, wherein the binding agent is a starch.

9. The removable protective coating of claim 2, wherein the dry removable protective coating is removable by operation of a cleaning blade or a cleaning blade/brush disposed in close proximity to the photoreceptor surface.

10. A light shock resistant imaging member, comprising:
a photoreceptive surface; and
a removable protective coating adjacent to the photoreceptive surface, the removable protective coating including:
a colorant,
a lubricant,
a binding agent, and
a solution mixing the colorant, lubricant and binding agent applied to the photoreceptive surface forming the removable protective coating on the photoreceptive surface.

11. The light shock resistant imaging member of claim 10, wherein the removable protective coating is formed on the photoreceptive surface at a predetermined thickness selected in accordance with a selected fractional transmittance.

12. The light shock resistant imaging member of claim 11, wherein the fractional transmittance is proportional to the predetermined thickness and an amount of colorant.

13. The light shock resistant imaging member of claim 12, wherein the lubricant is a stearate powder lubricant selected from the group consisting of magnesium stearate, zinc stearate, and polymethylmethacrylate.

14. The light shock resistant imaging member of claim 13, wherein the imaging member is a belt type photoreceptor or a drum type photoreceptor.

15. The light shock resistant imaging member of claim 14, wherein the colorant is a toner.

16. An image forming system, comprising:
a developer apparatus, including:
a housing defining a chamber storing a supply of toner therein, and
a developer roll disposed in the chamber, the developer roll configured to rotate about a longitudinal access to transport toner on a surface of the developer roll to a development zone;
a photoreceptor in contact with the developer roll, the photoreceptor configured to rotate about a longitudinal access and receive toner on a surface of the photoreceptor from the developer roll in the development zone, the photoreceptor surface having a removable protective coating disposed thereon, the removable protective coating including:
a colorant comprising the toner,
a lubricant,
a binding agent, and
a solution mixing the colorant, lubricant and binding agent applied to the photoreceptive surface forming the removable protective coating on the photoreceptive surface;
a charging member in proximity to the photoreceptor, the charging member configured to generate a predetermined electrical charge on the photoreceptor;
a cleaning blade in contact with the surface of the photoreceptor configured to remove the removable protective coating therefrom during rotation of the photoreceptor; and
a transfer belt in contact with the photoreceptor, the transfer belt configured to receive an image formed on the photoreceptor of toner and transfer the image to an output media.

17. The image forming system of claim 16, wherein the lubricant is a stearate powder lubricant selected from the group consisting of magnesium stearate, zinc stearate, and polymethylmethacrylate

18. A method for producing a removable protective coating on an associated imaging member, the method comprising:
determining a type of photoreceptor;
determining a light shock sensitivity in accordance with the determined type of photoreceptor;
determining lubrication requirements associated with the determined type of photoreceptor;
calculating an amount of a colorant, a lubricant, a binding agent, and a solution in accordance with the light shock sensitivity and lubrication requirements; and
applying the calculated amounts of colorant, lubricant, and binding agent in the solution to a surface of the associated imaging member drying to form the removable protective coating thereon.

19. The method for producing a removable protective coating of claim 18, further comprising:
calculating a percentage of light to block in accordance with the determined light shock sensitivity; and
calculating a thickness of the removable protective coating in accordance with the determined light shock sensitivity and lubrication requirements, wherein the amounts of colorant, lubricant, binding agent, and solution are calculated in accordance with the calculated thickness.

20. The method for producing a removable protective coating of claim 19, wherein applying the removable protective coating to the surface of the associated imaging member is performed via brushing, spraying, or dipping.
